(19) United States
(12) Patent Application Publication
(10) Pub. No.: US 2024/0317642 A1
(43) Pub. Date: Sep. 26, 2024

(54) IMPROVED POZZOLAN AND METHODS OF MAKING AND USING SAME

(71) Applicant: PROGRESSIVE PLANET SOLUTIONS INC., Vancouver (CA)

(72) Inventors: Stephen HARPUR, Salmon Arm (CA); Ian GRANT, Kamloops (CA); Roger MAH, Calgary (CA)

(21) Appl. No.: 18/573,884

(22) PCT Filed: Jul. 18, 2022
(86) PCT No.: PCT/CA2022/051111

§ 371 Date: Dec. 22, 2023

Related U.S. Application Data
(60) Provisional application No. 63/222,912, filed on Jul. 16, 2021.

(51) Int. Cl. C04B 7/24; C04B 7/02; C04B 7/40; C04B 7/52; C04B 7/60; C04B 28/04; C04B 40/02

(52) U.S. Cl. CPC C04B 7/24; C04B 7/02; C04B 7/40; C04B 7/52; C04B 7/60; C04B 28/04; C04B 40/0231

(57) ABSTRACT

A process for producing a pozzolan from a starting material. The starting material is size-reduced and incorporated into an aqueous slurry. The size-reduction can be carried out before or after incorporation into the aqueous slurry. Pressurized gas containing carbon dioxide is supplied to the aqueous slurry, and the aqueous slurry is mixed in the presence of the pressurized gas for a treatment period.

### CROSS-REFERENCE TO RELATED APPLICATIONS

This application claims priority to, and the benefit of, U.S. provisional patent application No. 63/222,912 filed 16 Jul. 2021, the entirety of which is incorporated by reference herein.

### TECHNICAL FIELD

Some embodiments relate to systems and methods for improving properties of a pozzolan material. In some embodiments, the material is glass. In some embodiments, the treated material is useful as a pozzolan or supplementary cementitious material in cement.

### BACKGROUND

Concrete is a composite material incorporating aggregate material bonded together with a cement paste that hardens as it cures over time. To form concrete structures, the aggregate material is mixed with cement and water to form a slurry that can be molded to a desired shape. The cement reacts with water and other components of the mixture to form a hard matrix that binds the materials together into a durable stone-like material.

Concrete is the most widely used building material in the world. Significant greenhouse gas, including carbon dioxide (CO₂), emissions are associated with the production of concrete, and in particular with cement used in the concrete. It is estimated that the production of cement (e.g. Portland cement) produces as much as 8% of the world's greenhouse gas emissions.

Materials such as pozzolans (or supplementary cementitious materials) can be added to cement or concrete to improve the working properties of the mixture and/or the physical parameters of the finished material. Pozzolans can also help to reduce the production of greenhouse gases associated with the production of concrete, by reducing the amount of material such as Portland cement that must be used in the concrete. Glass is a type of pozzolan, although it can have certain undesirable properties when used as such.

Alkali-silica reactivity occurs when silica contained in certain aggregates reacts with alkali hydroxide in concrete (e.g. NaOH, KOH) to form a gel (e.g. sodium silicate) that is hygroscopic and that swells as it adsorbs water from the surrounding cement paste or from the external environment. As this gel expands, it can crack the concrete, potentially causing structural damage.

One of the potential downsides of using glass as a pozzolan is that it may not fully mitigate alkali-silica reactivity in concrete to below 0.10% expansion at 14 days in accordance with ASTM standards.

There is a general desire for improved pozzolans for use in the manufacture of concrete that can reduce the greenhouse gas emissions associated with concrete production, and methods of their production.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a process for producing a pozzolan from a starting material. The starting material is size-reduced to a desired size to physically activate alkali metals in the starting material. The starting material is combined with water to form an aqueous slurry, and pressurized gas containing carbon dioxide is supplied to the aqueous slurry to chemically activate alkali metals in the starting material. The aqueous slurry can be mixed in the presence of the pressurized gas for a treatment period. In some aspects, the size reduction of the starting material is conducted prior to forming the aqueous slurry. In some aspects, the size reduction of the starting material is conducted after forming the aqueous slurry, so that the pressurized gas treatment in aqueous solution occurs simultaneously with the size reduction of the starting material. In some aspects, the pressurized gas contains carbon dioxide in a concentration of between about 5% and 100%. In some aspects, the pressurized gas contains other gases such as CO, SO₂, NO, and/or NO₂. In some aspects, the starting material is glass, including post-consumer waste glass. In some aspects, the glass is E-glass, flat glass, plate glass, glass bottles and/or glass jars, and/or windshields. In some aspects, the chemically and physically activated alkali metals, including e.g. sodium, are washed out of the glass in the aqueous slurry by removal of water, to improve performance characteristics of the pozzolan, such as by reducing alkali-silica reactivity and/or increasing compressive strength of a concrete product incorporating the treated pozzolan produced by the process.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an example embodiment of a method for manufacturing a pozzolan from a starting material.

FIG. 2 shows a second example embodiment of a method for manufacturing a pozzolan from a starting material.

FIG. 3 shows a third example embodiment of a method for manufacturing a pozzolan from a starting material, using the pH of the reaction mixture to control the treatment period.

FIG. 4 shows an example embodiment of an apparatus for manufacturing a pozzolan from a starting material.

FIG. 5 shows a second example embodiment of an apparatus for manufacturing a pozzolan from a starting material.

FIG. 6 shows the particle size classes versus volume density (%) for a sample of glass ground according to one example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The inventors have now discovered a process of producing a pozzolan that results in both sequestration of greenhouse gases such as carbon dioxide during production of the pozzolan, and which also minimizes the alkali-silica reactivity of concrete produced with the pozzolan. In some aspects, alkali metals including sodium ions are removed from the pozzolan during the process.

More specifically a wet grinding process of a slurry of the starting material in water under carbon dioxide pressure is carried out to both physically and chemically activate alkali metals in the starting material for removal in aqueous solution. In some embodiments, the starting material is glass. Without being bound by theory, during this wet grinding process, carbon dioxide (CO₂) is converted to carbonic acid (H₂CO₃), which then reacts with sodium oxide (Na₂O) or sodium hydroxide (NaOH) to chemically activate the sodium. Production of Na₂CO₃ then results in regeneration of 1 or 2 water molecule(s) (H₂O) for reaction with Na₂O and NaOH respectively, which can be re-used in the process. Further, the produced Na₂CO₃ will exit the reaction mixture with the filtrate solution during dewatering to the extent it is soluble, while a portion of the produced Na₂CO₃ will form a stable precipitate in equilibrium with the soluble salt, with the relative amounts of precipitate versus soluble forms being pH-dependent. The stable precipitate will be incorporated into the concrete mix as stable Na₂CO₃. Thus the process can reduce alkali-silica reactivity of glass when used as a pozzolan by removing alkali metals such as sodium from the glass and thereby decreasing the alkalinity of the glass, as a portion of the sodium washes out of the pozzolan in the process solution. This process also sequesters some carbon dioxide via the formation of Na₂CO₃. The carbonic acid will also react with calcium and magnesium ions present in solution to form calcium carbonate (CaCO₃) and magnesium carbonate (MgCO₃).

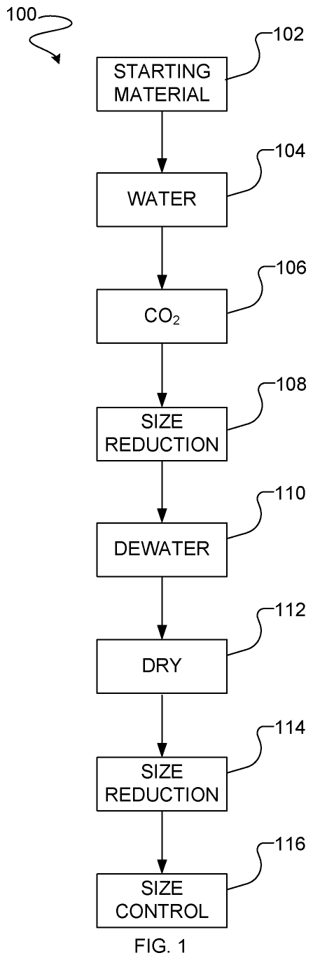

With reference to FIG. 1, an example embodiment of a method 100 for producing an improved pozzolan is illustrated. At 102, a starting material is supplied. At 104, the starting material is combined with water to produce a mixture in the form of an aqueous slurry. At 106, pressurized carbon dioxide is supplied to the mixture to chemically activate alkali metals in the starting material. In some embodiments, the pressurized carbon dioxide could be in combination with other gases, for example flue gases that are unprocessed or only partially processed, and which may contain other oxidizing gases such as CO, SO₂, NO, NO₂, and the like. At 108, the mixture is milled for a treatment period to size reduce the starting material, physically activating alkali metals in the starting material for removal. At 110, the mixture is dewatered to yield the desired improved pozzolan product, with at least a portion of the chemically and physically activated alkali metals in the starting material being removed with the water. In some embodiments, after dewatering the mixture is dried at 112.

In some embodiments, the starting material supplied at 102 is glass. In some embodiments, the starting material is glass diverted from a waste stream, e.g. post-consumer glass waste such as container glass such as glass bottles and jars e.g. mason jar glass, E-glass, flat glass or plate glass such as windshields, and the like. In some embodiments, the starting material is soda-lime glass. In some embodiments, the starting material is subject to any suitable crushing or grinding process to render it suitable as a starting material before being used in method 100. For example, post-consumer glass waste may be received from consumers, processed to clean the glass, and crushed to a relatively uniform starting size, e.g. having average particle diameters of in the range of about 300 microns, before being used as a starting material in method 100.

In some embodiments, the starting material is supplied at 102 to a grinding mill such as a tumbling ball mill or a stirred bead mill that can be operated under pressure and the remaining steps 104, 106 and 108 are carried out in the grinding mill. In other embodiments, any suitable apparatus can be used. In embodiments in which the size reduction apparatus that is used is not suitable for pressurization, method 200 may be used rather than method 100 to avoid subjecting the size reduction apparatus to pressure when pressurized carbon dioxide containing gas is fed to the reaction mixture.

In some embodiments, at 104 the starting material is combined with water to yield a slurry or mixture. In some embodiments, the level of solids present in the mixture is between about 5% and about 50% by weight, including between about 10% and about 30% by weight, including any value or subrange therebetween, e.g. about 6, 7, 8, 9, 10, 11, 12, 13, 14, 15, 16, 17, 18, 19, 20, 21, 22, 23, 24, 25, 26, 27, 28, 29, 30, 32, 34, 36, 38, 40, 42, 44, 46, or 48% by weight. In some embodiments, the level of solids present in the mixture is approximately 20% by weight.

In some embodiments, a CO₂-solubilizer is added at 104. In some embodiments, the CO₂-solubilizer is glycerin (propane-1,2,3-triol). In some embodiments, the CO₂-solubilizer is added to the mixture at a rate of about 6 g per kg of starting material. Without being bound by theory, it is believed that glycerin may act to enhance the solubility of carbon dioxide in aqueous solution and may allow for the formation of a greater carbonic acid (H₂CO₃) concentration for conducting the desired acid-base reaction to sequester carbon and remove alkali metal salts. In some embodiments, the CO₂-solubilizer is omitted.

In some embodiments, other additives are added at 104. In some embodiments, TiO₂ is added at 104, which without being bound by theory may assist in carbonating NaOH. In some embodiments, the TiO₂ is added to the mixture at a ratio of about 1% by weight of dry matter (i.e. at a rate of about 1% by weight of the starting material). In some embodiments, the other additive such as TiO₂ is omitted.

In some embodiments, at 106, a pressurized gas such as carbon dioxide is supplied. In some embodiments, the pressurized gas contains carbon dioxide at a concentration in a range of between about 5% and about 100%, including any value therebetween, e.g. 10, 15, 20, 25, 30, 35, 40, 45, 50, 55, 60, 65 70, 75, 80, 85, 90 or 95%. In some embodiments, the pressurized gas includes other gases, for example flue gases that are unprocessed or only partially processed, and which may contain other oxidizing gases such as CO, SO₂, NO, NO₂, and the like. In some embodiments, the pressure of the pressurized gas that is added to the reaction mixture is in the range of about 5 to about 150 psi gauge, including between about 20 to about 100 psi gauge, including any value or subrange therebetween, e.g. 10, 15, 20, 25, 30, 35, 40, 45, 50, 55, 60, 65, 70, 75, 80, 85, 90, 95, 100, 105, 110, 115, 120, 125, 130, 135, 140 or 145 psi gauge. The pressure at which the carbon dioxide is supplied could be adjusted by the person skilled in the art to remain within the maximum pressure limits of the apparatus being used to conduct the process, while still being high enough to dissolve a sufficient amount of carbon dioxide to yield a desired amount of carbonic acid to chemically activate alkali metals in the starting material.

In some embodiments, after an initial addition of pressurized gas at 106, the pressure is reduced (e.g. by actuation of an appropriate valve on the reaction vessel), and a fresh introduction of pressurized gas to pressurize the reaction mixture is made, e.g. to the same or a similar pressure as described for step 106. This release of pressure and re-introduction of pressurized gas can be done at any time during steps 106 or 108. In some embodiments, these release and repressurization steps are carried out to vent off gases such as nitrogen and/or oxygen, and/or to introduce additional carbon dioxide gas, as carbon dioxide gas is consumed in the course of reactions to form sodium and calcium carbonates and the like. In some embodiments in which the pressurized gas that is used contains a high partial pressure of carbon dioxide, it is not necessary to carry out such a step of pressure reduction and re-introduction of pressurized gas.

In some embodiments at 108, size reduction of the starting material is carried out to physically activate alkali metals in the starting material. In some embodiments, the mixture is combined with mild steel ball media at step 108 and grinding is carried out for a treatment period. In one example embodiment, approximately 10 kg of mild steel ball media is added per kg of starting material and a mild steel grinding mill is used (under pressure from the pressurized carbon dioxide) to carry out size reduction step 108. In other embodiments, size reduction can be carried out in any suitable manner.

In some embodiments, the size reduction step 108 is carried out for a treatment period of between about 30 minutes and about 12 hours, including between about 2 hours and about 10 hours, including any value or subrange therebetween, e.g. about 1, 1.5, 2, 2.5, 3, 3.5, 4, 4.5, 5, 5.5, 6, 6.5, 7, 7.5, 8, 8.5, 9, 9.5, 10, 10.5, 11 or 11.5 hours. In some embodiments by way of example only, the size reduction step 108 is carried out for a treatment period of approximately 4 hours. The duration of the treatment period can be adjusted by one skilled in the art based on the input size of the starting material and the grinding intensity applied to the starting material. For example, grinding under higher pressure in a stirred mill may require less processing time than grinding in a ball mill at atmospheric pressure.

In some embodiments, the size reduction step 108 is carried out at ambient temperature. In some embodiments, the size reduction step 108 is carried out at a temperature in the range of about 10° C. to about 80° C., including any temperature or subrange therebetween, e.g. 15, 20, 25, 30, 35, 40, 45, 50, 55, 60, 65, 70 or 75° C. In some embodiments, the only heat supplied at size reduction step 108 is the friction heat generated by the size reduction of the starting material.

In some embodiments, the size reduction step 108 is carried out until the starting material reaches a desired size profile. In one example embodiment in which the starting material is glass, the glass is ground to have a D50 passing in the range of about 2 to about 15 μm, including any value or subrange therebetween, e.g. about 3, 4, 5, 6, 7, 8, 9, 10, 11, 12, 13, 14 or 15 μm, and including between about 5 to about 15 μm.

It is noted that ASTM C1886/C1886M requires that a minimum of 95% of glass powder to be incorporated into concrete passes a 325-mesh wet sieve. In some embodiments, the glass is ground to a sufficient extent to be compliant with this or any other applicable requirement.

After the size reduction step 108 has been completed, the resultant mixture is dewatered in any suitable manner at step 110 to remove at least a portion of the chemically and physically activated alkali metals from the treated material. For example, the material could be filtered through a sieve of appropriate mesh or liquid suctioned off to yield the desired end product. In some embodiments, centrifuging could be used to precipitate or sediment the desired solids and allow for removal of the liquid supernatant, a hydrocyclone could be used, a thickener settling tank could be used, and/or fine-mesh pressure filtering could be carried out, or the like.

In some embodiments, at step 112, the resultant product is dried in any suitable manner. In some embodiments, drying is conducted e.g. at a temperature in the range of about 10° C. to about 40° C., including any value or subrange therebetween e.g. 15, 20, 25, 30, or 35° C. after pressure filtration for a suitable drying period, e.g. overnight (i.e. at least eight hours). The person skilled in the art could adjust the drying conditions to be suitable for any particular material and desired level of dryness. For example, the temperature at which the drying is conducted may vary depending on the ambient air moisture level, the remaining moisture content in the processed material after dewatering, drying volume capacity, and so on. The drying conditions can be selected to dry the treated material to any desired level, e.g. to render the treated pozzolan material compliant with ASTM C1866 requirements (0.5% maximum moisture content), or any other applicable standard.

In some embodiments, after the product is dried, size homogenization may be conducted at 114 to return the finished product to the same size range as was achieved prior to conducting carbonization with pressurized gas (i.e. for glass in one example embodiment a D50 passing in the range of about 2 to about 15 μm, including any value or subrange therebetween, e.g. about 3, 4, 5, 6, 7, 8, 9, 10, 11, 12, 13, 14 or 15 μm, and including between about 5 and about 15 μm). Without being bound, in some aspects agglomeration may occur as the product is dewatered and dried and so this additional size homogenization or grinding step can be carried out in any suitable manner to return the final product to the desired size for subsequent use, e.g. in cement and ultimately concrete. For example, in some embodiments, size homogenization is carried out via a short period of ball milling.

In some embodiments, subsequent to size homogenization, at step 116 a quality control step is carried out to ensure particles outside of a desired size range are removed from the pozzolan powder product. In some embodiments, the quality control step is conducted by air classification to remove undesirably large particles from the pozzolan powder product.

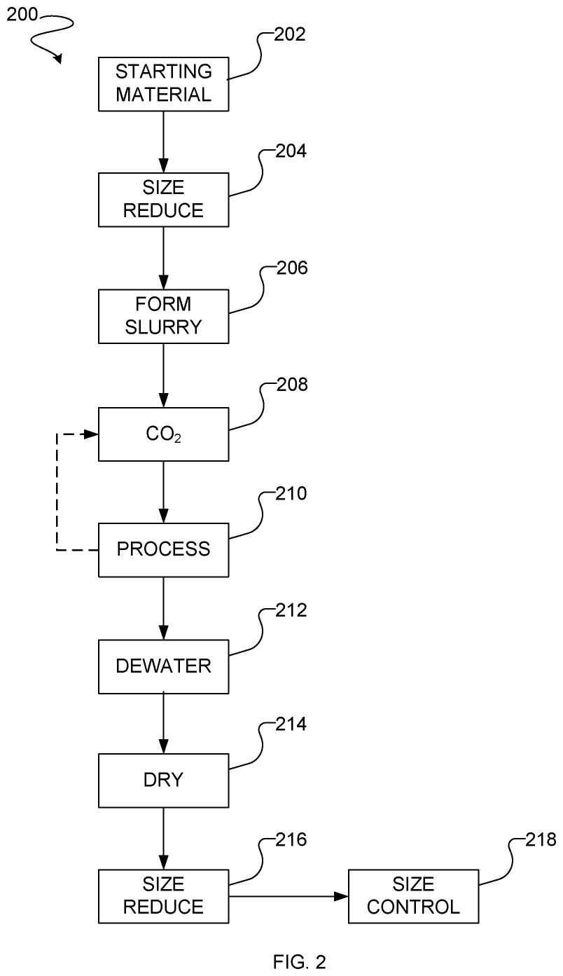

With reference to FIG. 2, a second example embodiment of a process 200 for producing a pozzolan from a starting material is illustrated. At 202, a starting material is supplied and at 204 the starting material is size reduced to the desired size range to physically activate alkali metals in the starting material. In some embodiments, the starting material is ground to the desired size range in a dry ball mill, stirred mill, or in any other suitable apparatus. In one example embodiment in which the starting material is glass, the glass is ground to have a D50 passing in the range of about 2 to about 15 μm, including any value or subrange therebetween, e.g. about 3, 4, 5, 6, 7, 8, 9, 10, 11, 12, 13, 14 or 15 μm, including between about 5 and about 15 μm. Any of the starting materials described for method 100 could be treated by method 200. Step 204 can be conducted at any desired pressure, e.g. at atmospheric pressure or as a pressurized process if desired.

It is noted that ASTM C1886/C1886M requires that a minimum of 95% of glass powder to be incorporated into concrete passes a 325-mesh wet sieve. In some embodiments, the glass is ground to a sufficient extent to be compliant with this or any other applicable requirement.

At 206, the size-reduced starting material is combined with water to form a slurry or mixture. In some embodiments, the amount of water added at 206 is sufficient so that the level of solids present in the mixture is between about 5% and about 50% by weight, including between about 10% and about 30% by weight, including any value or subrange therebetween, e.g. about 6, 7, 8, 9, 10, 11, 12, 13, 14, 15, 16, 17, 18, 19, 20, 21, 22, 23, 24, 25, 26, 27, 28, 29, 30, 32, 34, 36, 38, 40, 42, 44, 46, or 48% by weight. In some embodiments, the level of solids present in the mixture is approximately 20% by weight. In some embodiments, step 206 is conducted in a ball mill with no media. In some embodiments, the ball mill is a wet ball mill (e.g. rubber lined with standard lifters to agitate the mixture).

In some embodiments, a CO₂-solubilizer is added at 206. In some embodiments, the CO₂-solubilizer is glycerin (propane-1,2,3-triol). In some embodiments in which the CO₂-solubilizer is glycerin, the CO₂-solubilizer is added to the mixture at a rate of about 6 g per kg of starting material. In some embodiments, other additives are added at 206. In some embodiments, TiO₂ is added at 206, which without being bound by theory may assist in carbonating NaOH. In some embodiments, the TiO₂ is added to the mixture at a ratio of about 1% by weight of the dry matter in the mixture. In some embodiments, the CO₂-solubilizer and/or other additive is omitted.

At 208, CO₂ or other pressurized gas is supplied to the reaction mixture in any suitable reaction vessel, e.g. a pressure reactor, a pressure vessel with an agitator inside, or the like. In some embodiments, the pressure vessel contents are agitated during processing, e.g. by recirculating the slurry with a pump so that the pressure vessel contents are agitated with the pump flow. In some embodiments, the slurry bed is fluidized with a carbon dioxide gas recirculation pump. In some embodiments, the pressurized carbon dioxide could be in combination with other gases, for example flue gases that are unprocessed or only partially processed, and which may contain other oxidizing gases such as CO, SO₂, NO, NO₂, and the like. In some embodiments, the pressure of the pressurized gas that is added to the reaction mixture is in the range of about 5 to about 150 psi gauge, including between about 20 to about 100 psi gauge, including any value or subrange therebetween, e.g. 10, 15, 20, 25, 30, 35, 40, 45, 50, 55, 60, 65, 70, 75, 80, 85, 90, 95, 100, 105, 110, 115, 120, 125, 130, 135, 140 or 145 psi gauge. The pressure at which the carbon dioxide is supplied could be adjusted by the person skilled in the art to remain within the maximum pressure limits of the apparatus being used to conduct the process, while still being high enough to dissolve a sufficient amount of carbon dioxide to yield a desired amount of carbonic acid to chemically activate alkali metals in the starting material.

In some embodiments, after an initial addition of pressurized gas at 208, the pressure is reduced (e.g. by actuation of an appropriate valve on the reaction vessel), and a fresh introduction of pressurized gas to pressurize the reaction mixture is made. This release of pressure and re-introduction of pressurized gas can be done at any time during steps 208 or 210. In some embodiments, these release and repressurization steps are carried out to vent off gases such as nitrogen and/or oxygen, and/or to introduce additional carbon dioxide gas, as carbon dioxide gas is consumed in the course of reactions to form sodium and calcium carbonates and the like. In some embodiments in which the pressurized gas that is used contains a high partial pressure of carbon dioxide, it is not necessary to carry out such a step of pressure reduction and re-introduction of pressurized gas.

At 210, the reaction mixture is processed with the pressurized gas to facilitate dissolution of carbon dioxide to form carbonic acid, which reacts with alkali metals present in solution to both remove the alkali metals and sequester carbon. In some embodiments, step 210 is carried out for a treatment period of between about 30 minutes and about 12 hours, including between about 2 hours and about 10 hours, including any value or subrange therebetween, e.g. about 1, 1.5, 2, 2.5, 3, 3.5, 4, 4.5, 5, 5.5, 6, 6.5, 7, 7.5, 8, 8.5, 9, 9.5, 10, 10.5, 11 or 11.5 hours.

In some embodiments, step 210 is carried out at ambient temperature. In some embodiments, step 210 is carried out at a temperature in the range of about 10° C. to about 80° C., including any temperature or subrange therebetween, e.g. 15, 20, 25, 30, 35, 40, 45, 50, 55, 60, 65, 70 or 75° C.

After processing step 210 is completed, the mixture is dewatered at 212 in any appropriate manner to remove at least a portion of the physically and chemically activated alkali metals from the treated starting material with the water. For example, the material could be filtered through a sieve of appropriate mesh or liquid suctioned off to yield the desired end product. In some embodiments, centrifuging could be used to precipitate the desired solids and allow for removal of the liquid supernatant, a hydrocyclone could be used, a thickener settling tank could be used, and/or fine-mesh pressure filtering could be carried out, or the like.

In some embodiments, at step 214, the resultant product is dried in any suitable manner. In some embodiments, drying is conducted e.g. at a temperature in the range of about 10° C. to about 40° C., including any value or subrange therebetween e.g. 15, 20, 25, 30, or 35° C. after pressure filtration for a suitable drying period, e.g. overnight. The person skilled in the art could adjust the drying conditions to be suitable for any particular material and desired level of dryness. For example, the temperature at which the drying is conducted may vary depending on the ambient air moisture level, the remaining moisture content in the processed material after dewatering, drying volume capacity, and so on. The drying conditions can be selected to dry the treated material to any desired level, e.g. to render the treated pozzolan material compliant with ASTM C1866 requirements (0.5% maximum moisture content), or any other applicable standard.

In some embodiments, after the product is dried, size homogenization may be conducted at 216 to return the finished product to the same size range as was achieved prior to conducting carbonization with pressurized gas (i.e. for glass in one example embodiment a D50 passing in the range of about 2 to about 15 μm, including any value or subrange therebetween, e.g. about 3, 4, 5, 6, 7, 8, 9, 10, 11, 12, 13, 14 or 15 μm, and including between about 5 and about 15 μm). Without being bound, in some aspects agglomeration may occur as the product is dewatered and dried and so this additional size homogenization or grinding step can be carried out in any suitable manner to return the final product to the desired size for subsequent use, e.g. in cement and ultimately concrete. For example, in some embodiments, size homogenization is carried out via a short period of ball milling.

In some embodiments, subsequent to size homogenization, at step 218 a quality control step is carried out to ensure particles outside of a desired size range are removed from the pozzolan powder product. In some embodiments, the quality control step is conducted by air classification to remove undesirably large particles from the pozzolan powder product.

In some embodiments, the alkali metal that is chemically and physically activated and removed from the starting material by the removal of water from the aqueous solution through method 100 or 200 is sodium. In some embodiments, the amount of alkali metal in the form of sodium that is removed from glass as a starting material is in the range of about 10% to about 25%, including any value therebetween, e.g. 11, 12, 13, 14, 15, 16, 17, 18, 19, 20, 21, 22, 23 or 24%. In some embodiments, a process is provided for producing a ground glass pozzolan from a glass starting material, wherein the amount of sodium removed from the glass starting material to produce the ground glass pozzolan is in the range of about 10% to about 25%, including any value therebetween, e.g. 11, 12, 13, 14, 15, 16, 17, 18, 19, 20, 21, 22, 23 or 24%.

In some embodiments, the treated pozzolan is crushed glass having a D50 passing in the range of about 2 to about 15 μm, including any value therebetween, e.g. 3, 4, 5, 6, 7, 8, 9, 10, 11, 12, 13 or 14 μm. In some embodiments, the treated pozzolan is glass that has a carbon content of at least approximately 0.5% by weight, including e.g. at least approximately 0.4% or at least approximately 0.6%. In some embodiments, the treated pozzolan is glass that has a sodium content of between about 7.2% and 9.0%, including any value or subrange therebetween, e.g. 7.3, 7.4, 7.5, 7.6, 7.7, 7.8, 7.9, 8.0, 8.1, 8.2, 8.3, 8.4, 8.5, 8.6, 8.7, 8.8 or 8.9%.

In some embodiments, the treated pozzolan is used as a component of a cement mixture. For example, the treated pozzolan may be mixed with Portland cement to form a cement mixture. In some embodiments, the treated pozzolan is incorporated into cement at a rate of about 5% to about 70% w/w, including between 20% to 30% w/w, and including any value or subrange therebetween e.g. 5, 6, 7, 8, 9, 10, 11, 12, 13, 14, 15, 16, 17, 18, 19, 20, 21, 22, 23, 24, 25, 26, 27, 28, 29, 30, 32, 34, 36, 38, 40, 42, 44, 46, 48, 50, 52, 54, 56, 58, 60, 62, 64, 66 or 68% w/w. In some embodiments, the cement is incorporated into concrete at a ratio of approximately 15% w/w on a dry matter basis (e.g. about 10-20% w/w, including any value or subrange therebetween e.g. about 11, 12, 13, 14, 15, 16, 17, 18 or 19% w/w). In some embodiments, the treated pozzolan is incorporated into concrete in an amount of between about 1% to about 12%, including any value or subrange therebetween, e.g. about 2, 3, 4, 5, 6, 7, 8, 9, 10 or 11%.

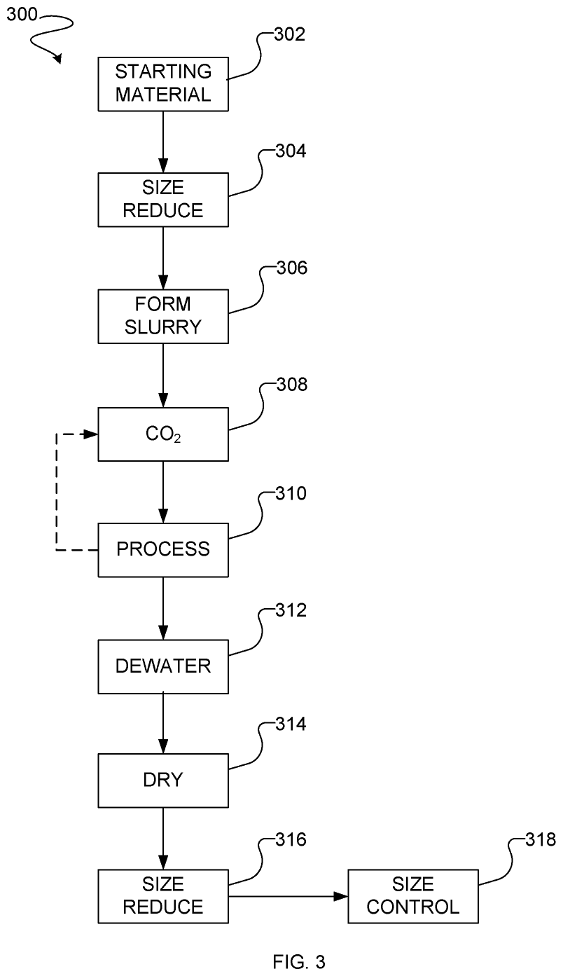

With reference to FIG. 3, in some embodiments the PH of the reaction mixture is used to determine the duration of the treatment period. More specifically, in an example embodiment of a method 300 for producing a treated pozzolan, changes in pH of the reaction mixture are used to determine the treatment period for the reaction mixture. Method 300 is generally similar to method 200, and equivalent steps are described with reference numerals incremented by 100 and are not further described again in detail.

In method 300, a starting material is provided at 302. In some embodiments, the stating material is post-consumer glass. At step 304, the starting material is size reduced to a desired particle size to physically activate alkali metals in the starting material, and at 306 an aqueous slurry is formed. At step 308, a pressurized source of carbon dioxide is provided, so that carbon dioxide gas is introduced into the aqueous slurry. At step 310, the reaction mixture is processed to allow the carbon dioxide to dissolve into the aqueous solution to form carbonic acid, which reacts with alkali metals present in the aqueous solution to both chemically activate the alkali metals for removal and sequester carbon.

In some embodiments, steps 304 and 310 are combined, so that the starting material is not size reduced prior to forming an aqueous slurry at step 306, but rather the starting material is size reduced during processing step 310.

Prior to the introduction of carbon dioxide, in embodiments in which the starting material is glass, e.g. post-consumer glass, the aqueous slurry at step 306 has a strongly alkaline pH, e.g. in the range of about 10.5-12.5, including any value therebetween e.g. 11.0, 11.5, or 12.0.

As carbon dioxide is introduced into the aqueous slurry, the carbon dioxide dissolves in the water and forms carbonic acid (H₂CO₃). As the concentration of carbonic acid in the aqueous slurry increases, the pH of the aqueous slurry will correspondingly decrease. In some embodiments, the addition of pressurized gas containing carbon dioxide continues at step 310 until the pH of the aqueous slurry reaches a predetermined low level of between about 4.0 and about 6.0, including any value therebetween (e.g. 4.5, 5.0 or 5.5). Once the pH reaches the predetermined low level, carbon dioxide introduction is stopped and processing step 310 is permitted to continue for a treatment period. In some embodiments, the treatment period is between about 0.5 hours and about 12 hours, including any value or subrange therebetween, e.g. about 1, 1.5, 2, 2.5, 3, 3.5, 4, 4.5, 5, 5.5, 6, 6.5, 7, 7.5, 8, 8.5, 9, 9.5, 10, 10.5, 11, or 11.5 hours.

After the introduction of pressurized gas containing carbon dioxide is stopped, the pH of the aqueous slurry will gradually increase as the carbonic acid reacts with alkali metal oxides in solution for a second period. In some embodiments, processing step 310 is halted after the pH of the aqueous slurry increases to a predetermined high level of about 6.0 to about 7.0, including any value therebetween, e.g. about 6.1, 6.2, 6.3, 6.4, 6.5, 6.6, 6.7, 6.8, or 6.9.

In some embodiments, after the pH of the aqueous slurry increases to the predetermined high level at step 310, step 308 is repeated and additional pressurized gas containing carbon dioxide is again introduced to the aqueous slurry, and step 310 is again repeated. For example, if the pH returns to a high level of about 11, this suggests that hydroxides still remain in solution and available for further reaction with carbonic acid, so that additional carbon dioxide should be added. Or if there is a substantial drop in pressure after additional pressurized gas containing carbon dioxide is added, this suggests that carbon dioxide continues to dissolve into the reaction mixture. Generally speaking, an excess amount of carbon dioxide is added relative to the level of sodium, calcium and magnesium ions present in the reaction mixture. Any excess carbon dioxide added to the process that does not dissolve into solution may be recaptured for use in further processing of additional starting material.

After completion of step 310, the aqueous slurry is dewatered at 312 to remove at least a portion of the physically and chemically activated alkali metals from the starting material with the water, dried at 314, and optionally size reduced at 316 to homogenize the size of the particles present, and/or optionally subject to a quality control step to ensure the presence of only particles having a desired size range at 318 as described for method 200.

While in the described embodiments the chemical activation of alkali metals in the starting material is achieved by the generation of carbonic acid in aqueous solution through the addition of pressurized carbon dioxide gas, other methods of chemical activation can be used in other embodiments. For example, treatment with other acids such as hydrochloric acid (HCl) can be used to chemically activate alkali metals for removal from the starting material, or treatment of the starting material with carbon dioxide without addition of water could be used to chemically activate alkali metals for removal from the starting material. Thus, in some embodiments, the step of chemical activation of the starting material by treatment of the starting material using carbon dioxide in the absence of any additional water introduction and relying on adsorbed water on the starting material (i.e. prior to addition of extrinsic water to the starting material) can be used in conjunction with a physical activation step (whether prior to, during or after the chemical activation step) effected by grinding of the starting material, followed subsequently by the generation of an aqueous slurry through the addition of water to the starting material to effect removal of the chemically and physically activated alkali metals using the water.

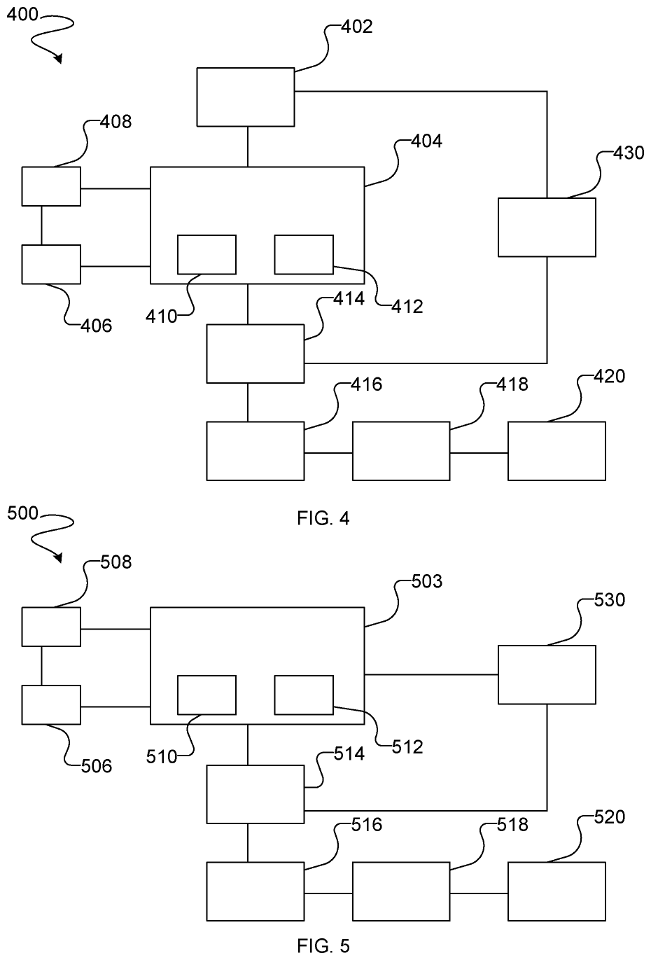

With reference to FIG. 4, an example embodiment of an apparatus 400 for processing a starting material to produce a treated pozzolan is illustrated. Apparatus 400 is suitable for use in methods 200 or 300, for example. Apparatus 400 includes a size reduction apparatus 402 such as a stirred-bead vertical mill (e.g. a VertiMill or HIGmill), horizontal mill (e.g. an IsaMill), or the like. While size reduction apparatus 402 could be an apparatus that could be pressurized, in some embodiments, for example where size reduction apparatus 402 is a vertical mill that is not typically pressurized, size reduction apparatus 402 is not suitable for operation under pressurized conditions and is operated only at atmospheric pressures.

Apparatus 400 further includes a pressure reactor 404, which is suitable for receiving pressurized gas containing carbon dioxide while processing the aqueous slurry of the starting material. In the illustrated embodiment, a pump 406 is provided to pump carbon dioxide containing gas from a carbon dioxide tank 408 into pressure reactor 404. In some embodiments, including the illustrated embodiment, carbon dioxide containing gas from the headspace above the aqueous slurry of starting material in pressure reactor 404 is recycled to carbon dioxide tank 408 via pump 406 and re-used in the process.

In some embodiments, including the illustrated embodiment, a pressure sensor 410 and/or a pH meter 412 are provided, so that the pressure and/or pH inside of pressure reactor 404 can be monitored.

From pressure reactor 404 for receiving the treated starting material after the treatment period is complete, a settling tank 414 is provided. Settling tank 414 can be used to dewater the treated reaction mixture. In some embodiments, water 430 that is recovered from settling tank 414 can be recycled for use in size reduction apparatus 402.

From settling tank 414, a pressure filter 416 can be provided in some embodiments to further dewater the treated reaction mixture. An air dryer 418 can be provided to dry the treated reaction mixture, and a size reduction apparatus such as a ball mill, rolls crusher, pulverizer or the like illustrated as 420 can be provided to carry out an additional size reduction step of the treated pozzolan material to help provide a homogenous particle size in the finished product.

With reference to FIG. 5, a second example embodiment of an apparatus 500 for processing a starting material to produce a treated pozzolan is illustrated. Apparatus 500 is suitable for use in method 100, for example. Apparatus 500 is generally similar to apparatus 400, and components thereof that perform like functions are illustrated with reference numeral incremented by 100 including pump 506, carbon dioxide tank 508, pressure sensor 510, pH meter 512, settling tank 514, pressure filter 516, air dryer 518 and pulverizer 520, which are not further described again.

Apparatus 500 differs from apparatus 400 in that instead of a separate size reduction apparatus 402 and pressure reactor 404, the size reduction apparatus and pressure reactor are provided as a single unit being size reduction apparatus 503, such as a ball mill, horizontal mill such as an ISAMill, or the like. Size reduction apparatus 503 is suitable for operation under pressure, so that the size reduction of the starting material can be carried out concurrently with the injection of pressurized carbon dioxide containing gas into the aqueous slurry of the starting material, as described for method 100. The pressure and/or pH inside size reduction apparatus can be monitored while the size reduction/carbon dioxide reaction steps are concurrently occurring using pressure sensor 510 and/or pH meter 512, and once the treatment of the starting material is completed, the starting material can be passed to settling tank 514 and treated similarly using pressure filter 516, air dryer 518 and pulverizer 520, to produce a final treated pozzolan product. Likewise, carbon dioxide containing gas from the headspace above the aqueous slurry inside size reduction apparatus 503 can be recycled for use by pump 506, and water 530 recovered from settling tank 514 can be recycled for use in size reduction apparatus 503.

### Example 1—Size Analysis of Ground Glass

An example method was conducted using a 1 kg sample of glass. The experiment was conducted using a mild steel grinding mill that had been modified to accept pressurized gas injection. The mill has an internal volume of approximately 15 L. The 1 kg sample of glass was combined with 80% w/w water (800 g) to produce a reaction mixture, and with 10 kg of mild steel ball media and 6 g of USP 99% glycerin. Pressurized carbon dioxide was added to a pressure of 27 psi gauge, and the reaction mixture was milled for a treatment period of four hours. The sample was ground to approximately 50% passing 7 μm.

Without being bound by theory, it is believed that complete reaction of the 13% Na₂O and 10% CaO by weight in glass sample with carbon dioxide to generate Na₂CO₃ and CaCO₂ is expected to require 136 L of carbon dioxide at standard temperature and pressure.

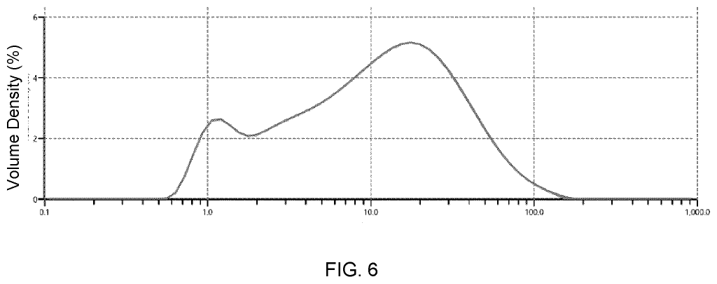

With reference to FIG. 6, the particle size distribution of post-consumer glass ground for four hours at 20% solids in the presence of pressurized carbon dioxide is shown. Three different sub-samples of the same sample were tested and the results for each of the three replicates overlie one another on FIG. 6, confirming that full size homogenization was achieved throughout the sample. The Dv (50) was determined to be 10.8 μm. The properties of the product are shown below in Table 1:

TABLE 1
Results of particle size analysis for glass ground according to
an example embodiment.

| | |
|---|---|
| Concentration | 0.0153% |
| Span | 3.632 |
| Uniformity | 1.172 |
| Dv (10) | 1.43 μm |
| Dv (50) | 10.8 μm |
| Dv (80) | 27.4 μm |
| Dv (90) | 40.8 μm |
| Dv (98) | 76.4 μm |

With reference to Table 2, the carbon, sodium and calcium content of both the starting material (feed) and treated product were determined:

TABLE 2
Elemental analysis of pozzolan material before and after treatment.

| Test | Product | % solids | C | Na | Ca |
|---|---|---|---|---|---|
| Feed | Crushed Glass | | 0.06 | 9.32 | 7.88 |
| Treated | 4 hr Wet Grind w CO2 Pressure | 20 | 0.61 | 7.75 | 7.02 |

### Example 2—Enhanced Strength of Concrete Made with Treated Glass Pozzolan

To evaluate the efficacy of removal of sodium from ground glass pozzolan in mitigating the effects of alkali-silica reactivity, a ground glass sample (1.00 kg) was screened to pass 850 μm and added to deionized water (935 mL) and ground down for 26.5 minutes achieving a pH of 11.6 in a batched stirred mill. The stirred mill had media changed out from 3-5 mm ceramic beads to 1.7-2.0 mm ceramic beads and attached to a recirculating feed tank. Deionized water (1.428 L) was added to the feed tank before running the stirred mill and pump for the recirculating feed tank. Excess HCl (0.865 L, 20%) was added to bring the pH of the solution down to 0.6 to effect acid removal of sodium ions from the treated glass (i.e. to chemically activate the sodium ions). The stirred mill with recirculating feed tank was run for 2 hours before a subsample was extracted for solid and solution assays. The stirred mill with recirculating feed tank was run for an additional hour, 3 hours total, before a second subsample was extracted for solid and solution assays. After 3 hours of mixing, the pH of the solution was 0.41 and the particle size distribution was 2.2 μm K50. The sample was allowed to sit in the acidic solution overnight (14 hours) and rose to a pH of 1.45 before a final solid and solution sample was collected for assays. The remaining slurry was pressure filtered and rinsed with deionized water before being incorporated into concrete and tested for alkali-silica reactivity (ASTM C1567) and strength activity index (ASTM C311).

Tables 3 and 4 show the efficacy of the acid treatment in removing sodium ions from the treated ground glass pozzolan: the amount of sodium removed increased with a longer treatment period (Table 3), and after the overnight soak following grinding of the glass starting material in aqueous solution, 20.7% of the sodium in the glass starting material had been removed (Table 4).

As can be seen from Tables 5 and 6, the treated ground glass pozzolan when incorporated into concrete exhibited both greater strength than an untreated ground glass pozzolan (113.4% of the strength of the control concrete made from Portland cement versus 83% for the untreated ground glass pozzolan, Table 5), and lower alkali silica reactivity (0.05% expansion in ASR testing versus 0.16 for untreated ground glass pozzolan, Table 6). Thus, this example demonstrates that removal of alkali metal ions, namely sodium, from the ground glass pozzolan is associated with both decreased alkali silica reactivity and enhanced strength of the concrete end product.

TABLE 3
Removal of sodium from glass starting material.

| | Solids Assay - % | | | Filtrate Assay - ppm | |
|---|---|---|---|---|---|
| Material | C | Na | Ca | Na | Ca |
| Feed Glass | 0.06 | 9.32 | 7.88 | | |
| 2-hour Grind with HCl | | 8.78 | 6.5 | 3215 | 1562 |
| 3-hour Grind with HCl | | 8.03 | 6.19 | 4918 | 2343 |
| Overnight Soak with HCl | | 7.54 | 6.14 | 5950 | 2939 |

TABLE 4
Calculation of sodium removed from glass starting material.

| Glass | 1 | kg | |
|---|---|---|---|
| Solids loading | 29.70% Solids | | |
| Water | 2.37 | L | |
| Acid (HCl) | 0.865 | L | |
| Total Solution | 3.235 | L | |
| Na Extracted | 19.2 | g | 5950 ppm/1000 * 3.235 L |
| Na in Feed | 9.32% | | |
| | 93.2 | g | 1 kg * 9.32% * 1000 |

| | | |
|---|---|---|
| Na remaining after extraction | 7.40% | (93.2 g − 19.2 g)/1000 |
| Na Extracted | 20.7% | (19.2 g/93.2 g) * 100 |

TABLE 5
Evaluation of strength of concrete made using treated vs.
untreated ground glass pozzolan.
ASTM C311 Strength Activity Index

| | 7-days | | 28-days | |
|---|---|---|---|---|
| | Strength | Index | strength | Index |
| | (MPa) | (%) | (MPa) | (%) |
| Ctrl (100% Portland | 28 | | 38.7 | |
| cement) | | | | |
| Untreated Ground Glass | 23.9 | 79 | 34.5 | 83 |
| Treated Ground Glass | 24.7 | 88.3 | 43.9 | 113.4 |

TABLE 6
Evaluation of alkali-silica reactivity of concrete made using
treated vs. untreated ground glass pozzolan.
ASTM C1567 Results (ASR Test - pass is <.10% expansion at 14 days):

| | Expansion | Expansion | Expansion | Expansion | |
|---|---|---|---|---|---|
| | (%) | (%) | (%) | (%) | |
| | 3 days | 7 days | 10 days | 14 days | |
| Ctrl (100% | 0.13 | 0.25 | 0.3 | 0.37 | FAIL |
| Portland cement) | | | | | |
| Untreated Ground | 0.04 | 0.1 | 0.12 | 0.16 | FAIL |
| Glass | | | | | |
| Treated Ground | 0.026 | 0.031 | 0.045 | 0.05 | PASS |
| Glass | | | | | |

### Example 3—Reduced Expansion of Concrete Made Using Treated Ground Glass Pozzolan

To evaluate the characteristics of concrete produced using the treated glass as a proof of concept, ASTM-C1567 testing was carried out on a sample produced from an early iteration of the described process. This test showed that the treated sample shows less expansion (0.11% at 14 days) than the original glass sample (0.16% at 14 days). Briefly, ASTM-C1567 testing involves mortar bars (25×25×285 mm) being produced with the aggregate of interest. The bars are stripped from their forms after 24 hours moist curing. The 1-day-old bars are then placed in water in a sealed plastic container at room temperature. The containers (and bars) are placed in an oven at 80° C. and remain there for 24 hours. The 2-day-old bars are removed from the water and are placed in a length-change comparator to establish the initial (reference) length. The bars are then placed in sealed plastic containers containing 1 molar sodium hydroxide solution—the solution having been preheated to 80° C. The bars are removed from the containers periodically and placed in the length comparator to determine the length change from the reference reading. The length change after 14 days in NaOH (bars are now 16 days old) is usually used as the performance indicator.

### Example 4—Removal of Sodium from Glass Starting Material

To demonstrate that treatment with pressurized carbon dioxide can effect a similar level of removal of sodium from ground glass as was achieved in Example 2, previously crushed post-consumer container glass (750 g) was screened with a #20 mesh screen (850 μm). Material passing through (−850 μm) was added along with water (1 L) to a stirred ceramic media mill and ground to a fine size of 2.5 μm Dv50 in two stages. The stirred mill discharge was separated from the grinding media and the silica slurry was added to a reactor vessel with a recirculating pump. Initial pH of the slurry was 11.9. Water was added for adequate pumping.

CO₂ gas was introduced into the sealed reactor vessel to a pressure of 60 psi. The reactor was operated at this pressure for a period of 5 hours, at which point the pH was 5.7. The reactor was then depressurized and a slurry sample was taken and filtered for assays, the pH of this sample was 6.5. The CO₂ reactor was again increased in pressure to 80 psi and allowed to continue for 3 additional hours, for 8 hours total processing time, at which point the pH was 5.5. The reactor was depressurized and an 8 hour sample was taken and filtered, the pH of this sample was 6.6. Solids samples were assayed directly for alkali content (Na, Ca, Mg). Slurry samples were pressure filtered with a 2 μm cloth and the liquid filtrate and solid residues were assayed separately for alkali content (Na, Ca, Mg).

Results are presented in Tables 7 and 8. It can be seen that the sodium (Na) content of the crushed glass feed has been lowered from 9.42% to about 7.5%. Sodium was removed in the both the stirred mill stage and the pressure-reactor stage, and it remained dissolved in solution as shown in the filtrate liquid assay. The processing via treatment of an aqueous slurry of the ground glass pozzolan with pressurized carbon dioxide resulted in the removal of 20.62% of the original sodium content from the ground glass pozzolan. Based on the similar level of alkali metal removal, specifically sodium, from the ground glass pozzolan as was achieved via acid treatment in Example 2, it is predicted that the ground glass pozzolan obtained via the process used in this Example will exhibit similar properties when evaluated for alkali-silica reactivity and strength in concrete.

TABLE 7
Analysis of treated ground glass pozzolan during processing.

| | Elements for Assay (%) | | |
|---|---|---|---|
| Product | Ca | Mg | Na |
| Crushed Glass (−20 mesh) | 7.62 | 0.73 | 9.42 |
| Stirred Mill Feed | 7.5 | 0.74 | 9.27 |
| Reactor Feed Solids Residue | 7.41 | 0.72 | 8.21 |
| 5 hr Reactor-processed Residue | 6.78 | 0.67 | 7.45 |
| 8 hr Reactor-processed Residue | 7.33 | 0.66 | 7.48 |
| Liquids: | (parts per million) | | |
| Reactor Feed Filtrate | <1 | <1 | 472 |
| 5 hr Final Filtrate | 195 | 17 | 492 |
| 8 hr Final Filtrate | 180 | 15 | 465 |

TABLE 8
Calculation of removal of sodium by treatment of aqueous slurry
of pozzolan with pressurized carbon dioxide.

| | |
|---|---|
| 1.968 | g removed with 4 L sampling at 5 hrs |
| 8.943 | g removed total (1.968 g + 6.975 g) |
| 500 | g total glass in reactor |
| 1.79% | Na removal from liquid calculation |
| 18.98% | of original Na removed, liquid |
| | calculation |
| 1.94% | Na removal from solids calculation |
| 20.62% | of original Na removed, solids |
| | calculation |

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A process for producing a pozzolan from a starting material, comprising the steps of:
size-reducing the starting material;
forming an aqueous slurry containing the starting material;
supplying pressurized gas containing carbon dioxide to the aqueous slurry; and
mixing the aqueous slurry in the presence of the pressurized gas for a treatment period.

2. A process as defined in claim 1, wherein the step of size-reducing the starting material is conducted prior to forming the aqueous slurry, wherein optionally the size reduction step is conducted in a vertical mill.

3. A process as defined in claim 1, wherein the step of size-reducing the starting material is conducted after forming the aqueous slurry, optionally wherein the mixing of the aqueous slurry in the presence of the pressurized gas is carried out in a tumbling ball mill, a stirred bead mill or a horizontal mill.

4. A process as defined in claim 1, further comprising dewatering the aqueous slurry after the step of supplying pressurized gas containing carbon dioxide to the aqueous slurry to form a dewatered pozzolan, wherein the step of dewatering the aqueous slurry optionally comprises filtration, sedimentation, use of a hydrocyclone, and/or use of a thickener settling tank.

5. A process as defined in claim 4, comprising drying the dewatered pozzolan.

6. A process as defined in claim 5, wherein drying the dewatered pozzolan comprises drying at ambient temperature for a period of at least eight hours.

7. A process as defined in claim 1, further comprising a second size reduction step conducted subsequent to the step of drying the dewatered pozzolan, wherein optionally the second size reduction step is conducted using a ball mill, rolls crusher or pulverizer.

8. A process as defined in claim 1, further comprising a step of removing undesirably large particles after the step of drying the dewatered pozzolan or after the second size reduction step, wherein the step of removing undesirably large particles optionally comprises air classification.

9. A process as defined in claim 1, wherein the pressurized gas containing carbon dioxide comprises carbon dioxide and one or more of CO, SO₂, NO, and/or NO₂.

10. A process as defined in claim 1, wherein the starting material comprises soda-lime glass.

11. A process as defined in claim 1, wherein the starting material comprises post-consumer glass waste, E-glass, flat glass or plate glass.

12. A process as defined in claim 11, wherein:
the post-consumer glass waste comprises glass bottles and/or glass jars, optionally wherein the glass jars comprise mason jars; and/or
the plate glass comprises windshields.

13. A process as defined in claim 1, wherein the step of forming an aqueous slurry comprises forming a slurry containing between about 5% and about 50% by weight of the starting material.

14. A process as defined in claim 1, wherein a carbon dioxide solubilizer is added to the aqueous slurry, wherein the carbon dioxide solubilizer optionally comprises glycerin, and wherein the glycerin is optionally added at a rate of about 6 g per kg of the starting material.

15. A process as defined in claim 1, wherein TiO₂ is added to the aqueous slurry, wherein the TiO₂ is optionally added at a rate of about 1% by weight of the starting material.

16. A process as defined in claim 1, wherein the pressurized gas containing carbon dioxide is supplied at a pressure of about 5 to about 150 psi gauge.

17. A process as defined in claim 1, wherein the pressurized gas contains carbon dioxide at a concentration of between about 5% and 100%.

18. A process as defined in claim 1, wherein the pressurized gas containing carbon dioxide is supplied for an initial period, following which the pressure is released from a vessel containing the aqueous slurry, following which the pressurized gas containing carbon dioxide is reintroduced to the vessel.

19. A process as defined in claim 18, wherein the pressurized gas containing carbon dioxide is supplied for the initial period until the pH of the aqueous slurry reaches a value between about 4.0, and about 6.0.

20. A process as defined claim 18, wherein subsequent to the pressurized gas containing carbon dioxide being reintroduced to the vessel, the aqueous slurry is processed for a second period until the pH of the aqueous slurry reaches a level of between about 6.0 and about 7.0.

21. A process as defined in claim 1, wherein the treatment period comprises between about 1 hours and about 12 hours.

22. A process as defined in claim 1, wherein the aqueous slurry is maintained at a temperature in the range of about 10° C. to about 80° C. during the treatment period.

23. A process as defined in claim 1, wherein the starting material is glass, and wherein the step of size-reducing the starting material is conducted until the glass has a D50 passing in the range of about 2 to about 15 μm.

24. A process for removing an alkali metal from glass to be used as supplementary cementitious material, the process comprising conducting a process as defined in claim 1, wherein the alkali metal is optionally sodium.

25. A process as defined in claim 24, wherein the amount of sodium removed from the glass as the starting material is between about 10% and about 25%.

26. A process for producing a ground glass pozzolan from a glass starting material, wherein the amount of sodium removed from the glass starting material to produce the ground glass pozzolan is in the range of about 10% to about 25%.

27. A process for producing a treated pozzolan from a starting material, the process comprising chemically activating at least one alkali metal in the starting material, physically activating the at least one alkali metal in the starting material, and washing the chemically and physically activated at least one alkali metal from the starting material using water to produce the treated pozzolan.

28. The process as defined in claim 27, wherein the starting material comprises glass, the at least one alkali metal comprises sodium, and/or the step of chemically activating the at least one alkali metal comprises exposing the starting material to carbon dioxide.

29. The process as defined in claim 27, wherein the steps of chemically and physically activating the at least one alkali metal are conducted prior to addition of water to the starting material.

30. The process as defined in claim 27, wherein the steps of at least one of chemically or physically activating the at least one alkali metal are conducted after addition of water to the starting material.

31. A pozzolan made by the process as defined in claim 1.

32. A pozzolan comprising crushed glass having a sodium content of approximately 7.2% to approximately 9.0% by weight.

33. A pozzolan as defined in claim 32 comprising crushed glass having a D50 passing in the range of about 2 to about 15 μm and optionally a carbon content of at least approximately 0.5% by weight.

34. A cement comprising a pozzolan as defined in claim 31.

35. A cement as defined in claim 34, wherein the pozzolan is present in an amount of about 5% to about 70% w/w.

36. A cement as defined in claim 34, comprising Portland cement.

37. Concrete comprising a pozzolan or a cement as defined in claim 31.

38. Concrete as defined in claim 37, wherein the pozzolan is present in an amount of between about 1% to about 12% by weight on a dry matter basis.
